(19) United States
(12) Patent Application Publication
(10) Pub. No.: US 2023/0019679 A1
(43) Pub. Date: Jan. 19, 2023

(54) IMAGE PROCESSING METHOD AND DEVICE, AND STORAGE MEDIUM

(71) Applicant: BEIJING SENSETIME TECHNOLOGY DEVELOPMENT CO., LTD., Beijing (CN)

(72) Inventors: Zhuojie CHEN, Beijing (CN); Ke YU, Beijing (CN); Xintao WANG, Beijing (CN); Chao DONG, Beijing (CN); Chenchange LOY, Beijing (CN); Xiaoou TANG, Beijing (CN)

(21) Appl. No.: 17/885,542

(22) Filed: Aug. 11, 2022

Related U.S. Application Data
(63) Continuation of application No. PCT/CN2020/100216, filed on Jul. 3, 2020.

(30) Foreign Application Priority Data
Feb. 28, 2020 (CN) 202010129837.1

(51) Int. Cl. G06T 3/40; G06V 10/62; G06T 7/246; G06T 3/00

(52) U.S. Cl. CPC G06T 3/4053; G06V 10/62; G06T 7/246; G06T 3/0093; G06T 2207/10016

(57) ABSTRACT

The present disclosure relates to image processing. The method includes acquiring at least one of a backward propagation feature of an (x+1)th video frame in a video segment or a forward propagation feature of an (x−1)th video frame in the video segment. The video segment includes N video frames, N being an integer greater than 2, and x being an integer. The method further includes deriving a reconstruction feature of the xth video frame from at least one of the xth video frame, the backward propagation feature of the (x+1)th video frame, or the forward propagation feature of the (x−1)th video frame, and deriving a target video frame corresponding to the xth video frame by reconstructing the xth video frame based on the reconstruction feature of the xth video frame. The target video frame has resolution higher than that of the xth video frame.

The present application is a continuation of and claims priority to PCT Application. No. PCT/CN2020/100216, filed on Jul. 3, 2020, which claims priority to Chinese Patent Application No. 202010129837.1 with the title of “Data Processing Method and Device, Electronic Apparatus, and Storage Medium”, filed with the CNIPA on Feb. 28, 2020. All the above referenced priority documents are incorporated herein by reference.

### TECHNICAL FIELD

The present disclosure relates to the technical field of computer technology, in particular to an image processing method and device, an electronic apparatus, and a storage medium.

### BACKGROUND

Video super-resolution aims to reconstruct a high-resolution video corresponding to a given low-resolution video. The relevant technology predicts a high-resolution video frame by using multiple low-resolution video frames, and the reconstructed video frame has resolution higher than that of the pro-reconstruction video frame. The resulting video thus has higher definition.

### SUMMARY

The present disclosure provides a technical solution for reconstructing a high-resolution video frame.

According to one aspect of the present disclosure, there is provided an image processing method comprising:

acquiring at least one of a backward propagation feature of an (x+1)th video frame in a video segment and a forward propagation feature of an (x−1)th video frame in the video segment, wherein the video segment includes N video frames, N being an integer greater than 2, and x being an integer;

deriving a reconstruction feature of the xth video frame from at least one of the xth video frame, the backward propagation feature of the (x+1)th video frame, and the forward propagation feature of the (x−1)th video frame; and

deriving a target video frame corresponding to the xth video frame by reconstructing the xth video frame based on the reconstruction feature of the xth video frame, wherein the target video frame has resolution higher than that of the xth video frame.

In a possible implementation, in the case of 1<x<N, deriving a reconstruction feature of the xth video frame from at least one of the xth video frame, the backward propagation feature of the (x+1)th video frame, and the forward propagation feature of the (x−1)th video frame comprises:

determining a backward propagation feature of the xth video frame based on the xth video frame, the (x+1)th video frame, and the backward propagation feature of the (x+1)th video frame;

determining a forward propagation feature of the xth video frame based on the xth video frame, the (x−1)th video frame, the forward propagation feature of the (x−1)th video frame, and the backward propagation feature of the xth video frame; and

using the forward propagation feature of the xth video frame as a reconstruction feature of the xth video frame.

In a possible implementation, determining a backward propagation feature of the xth video frame based on the xth video frame, the (x+1)th video frame, and the backward propagation feature of the (x+1)th video frame comprises:

deriving a first optical flow diagram from the xth video frame and the (x+1)th video frame;

deriving a distorted backward propagation feature by distorting the backward propagation feature of the (x+1)th video frame based on the first optical flow diagram; and

deriving a backward propagation feature of the xth video frame from the distorted backward propagation feature and the xth video frame.

determining a forward propagation feature of the xth video frame based on the xth video frame, the (x−1)th video frame, the forward propagation feature of the (x−1)th video frame, and the backward propagation feature of the xth video frame comprises:

deriving a second optical flow diagram from the xth video frame and the (x−1)th video frame;

deriving a distorted forward propagation feature by distorting the forward propagation feature of the (x−1)th video frame based on the second optical flow diagram; and

deriving a forward propagation feature of the xth video frame from the backward propagation feature of the xth video frame, the distorted forward propagation feature, and the xth video frame.

In a possible implementation, in the case of 1<x<N, deriving a reconstruction feature of the xth video frame from at least one of the xth video frame, the backward propagation feature of the (x+1)th video frame, and the forward propagation feature of the (x−1)th video frame comprises:

determining a forward propagation feature of the xth video frame based on the xth video frame, the (x−1)th video frame, and the forward propagation feature of the (x−1)th video frame;

determining a backward propagation feature of the xth video frame based on the xth video frame, the (x+1)th video frame, the backward propagation feature of the (x+1)th video frame, and the forward propagation feature of the xth video frame; and

using the backward propagation feature of the xth video frame as a reconstruction feature of the xth video frame.

In a possible implementation, determining a forward propagation feature of the xth video frame based on the xth video frame, the (x−1)th video frame, and the forward propagation feature of the (x−1)th video frame comprises:

deriving a second optical flow diagram from the xth video frame and the (x−1)th video frame;

deriving a distorted forward propagation feature by distorting the forward propagation feature of the (x−1)th video frame based on the second optical flow diagram; and

deriving a forward propagation feature of the xth video frame from the distorted forward propagation feature and the xth video frame.

In a possible implementation, determining a backward propagation feature of the xth video frame based on the xth video frame, the (x+1)th video frame, the backward propagation feature of the (x+1)th video frame, and the forward propagation feature of the xth video frame comprises:

deriving a first optical flow diagram from the xth video frame and the (x+1)th video frame;

deriving a distorted backward propagation feature by distorting the backward propagation feature of the (x+1)th video frame based on the first optical flow diagram; and

deriving a backward propagation feature of the xth video frame from the distorted backward propagation feature and the xth video frame.

In a possible implementation, in the case of x=1, deriving a reconstruction feature of the xth video frame from at least one of the xth video frame, the backward propagation feature of the (x+1)th video frame, and the forward propagation feature of the (x−1)th video frame comprises:

deriving a forward propagation feature of the xth video frame by performing feature extraction on the xth video frame; and

using the forward propagation feature of the xth video frame as a reconstruction feature of the xth video frame.

In a possible implementation, in the case of x=N, deriving a reconstruction feature of the xth video frame from at least one of the xth video frame, the backward propagation feature of the (x+1)th video frame, and the forward propagation feature of the (x−1)th video frame comprises:

deriving a backward propagation feature of the xth video frame by performing feature extraction on the xth video frame; and

using the backward propagation feature of the xth video frame as a reconstruction feature of the xth video frame.

In a possible implementation, in the case of x=1, deriving a reconstruction feature of the xth video frame from at least one of the xth video frame, the backward propagation feature of the (x+1)th video frame, and the forward propagation feature of the (x−1)th video frame comprises:

acquiring a backward propagation feature of the (x+1)th video frame for the xth video frame;

deriving a forward propagation feature of the xth video frame from the xth video frame and the backward propagation feature of the (x+1)th video frame; and

using the forward propagation feature of the xth video frame as a reconstruction feature of the xth video frame.

In a possible implementation, in the case of x=N, deriving a reconstruction feature of the xth video frame from at least one of the xth video frame, the backward propagation feature of the (x+1)th video frame, and the forward propagation feature of the (x−1)th video frame comprises:

acquiring a forward propagation feature of the (x−1)th video frame for the xth video frame;

deriving a backward propagation feature of the xth video frame from the xth video frame and the forward propagation feature of the (x−1)th video frame; and

using the backward propagation feature of the xth video frame as a reconstruction feature of the xth video frame.

In a possible implementation, the method further comprises:

determining at least two key frames in video data; and

dividing the video data into at least one video segment based on the key frames.

According to another aspect of the present disclosure, there is provided an image processing device comprising:

an acquiring module configured to acquire at least one of a backward propagation feature of an (x+1)th video frame in a video segment and a forward propagation feature of an (x−1)th video frame in the video segment, wherein the video segment includes N video frames, N being an integer greater than 2, and x being an integer;

a first processing module configured to derive a reconstruction feature of the xth video frame from at least one of the xth video frame, the backward propagation feature of the (x+1)th video frame, and the forward propagation feature of the (x−1)th video frame; and

a second processing module configured to derive a target video frame corresponding to the xth video frame by reconstructing the xth video frame based on the reconstruction feature of the xth video frame, wherein the target video frame has resolution higher than that of the xth video frame.

In a possible implementation, in the case of 1<x<N, the first processing module is further configured to determine a backward propagation feature of the xth video frame based on the xth video frame, the (x+1)th video frame, and the backward propagation feature of the (x+1)th video frame;

determine a forward propagation feature of the xth video frame based on the xth video frame, the (x−1)th video frame, the forward propagation feature of the (x−1)th video frame, and the backward propagation feature of the xth video frame; and

use the forward propagation feature of the xth video frame as a reconstruction feature of the xth video frame.

In a possible implementation, the first processing module is further configured to derive a first optical flow diagram from the xth video frame and the (x+1)th video frame;

derive a distorted backward propagation feature by distorting the backward propagation feature of the (x+1)th video frame based on the first optical flow diagram; and

derive a backward propagation feature of the xth video frame from the distorted backward propagation feature and the xth video frame.

In a possible implementation, the first processing module is further configured to derive a second optical flow diagram from the xth video frame and the (x−1)th video frame;

derive a distorted forward propagation feature by distorting the forward propagation feature of the (x−1)th video frame based on the second optical flow diagram; and

derive a forward propagation feature of the xth video frame from the backward propagation feature of the xth video frame, the distorted forward propagation feature, and the xth video frame.

In a possible implementation, in the case of 1<x<N, the first processing module is further configured to determine a forward propagation feature of the xth video frame based on the xth video frame, the (x−1)th video frame, and the forward propagation feature of the (x−1)th video frame;

determine a backward propagation feature of the xth video frame based on the xth video frame, the (x+1)th video frame, the backward propagation feature of the (x+1)th video frame, and the forward propagation feature of the xth video frame; and

use the backward propagation feature of the xth video frame as a reconstruction feature of the xth video frame.

In a possible implementation, the first processing module is further configured to derive a second optical flow diagram from the xth video frame and the (x−1)th video frame;

derive a distorted forward propagation feature by distorting the forward propagation feature of the (x−1)th video frame based on the second optical flow diagram; and

derive a forward propagation feature of the xth video frame from the distorted forward propagation feature and the xth video frame.

In a possible implementation, the first processing module is further configured to derive a first optical flow diagram from the xth video frame and the (x+1)th video frame;

derive a distorted backward propagation feature by distorting the backward propagation feature of the (x+1)th video frame based on the first optical flow diagram; and

derive a backward propagation feature of the xth video frame from the forward propagation feature of the xth video frame, the distorted backward propagation feature, and the xth video frame.

In a possible implementation, in the case of x=1, the first processing module is further configured to:

derive a forward propagation feature of the xth video frame by performing feature extraction on the xth video frame; and

use the forward propagation feature of the xth video frame as a reconstruction feature of the xth video frame.

In a possible implementation, in the case of x=N, the first processing module is further configured to:

derive a backward propagation feature of the xth video frame by performing feature extraction on the xth video frame; and

use the backward propagation feature of the xth video frame as a reconstruction feature of the xth video frame.

In a possible implementation, in the case of x=1, the first processing module is further configured to:

acquire a backward propagation feature of the (x+1)th video frame for the xth video frame;

derive a forward propagation feature of the xth video frame from the xth video frame and the backward propagation feature of the (x+1)th video frame; and

use the forward propagation feature of the xth video frame as a reconstruction feature of the xth video frame.

In a possible implementation, in the case of x=N, the first processing module is further configured to:

acquire a forward propagation feature of the (x−1)th video frame for the xth video frame;

derive a backward propagation feature of the xth video frame from the xth video frame and the forward propagation feature of the (x−1)th video frame; and

use the backward propagation feature of the xth video frame as a reconstruction feature of the xth video frame.

In a possible implementation, the device further comprises:

a determining module configured to determine at least two key frames in video data; and

a dividing module configured to divide the video data into at least one video segment based on the key frames.

According to still another aspect of the present disclosure, there is provided an electronic apparatus comprising a processor; and a memory for storing instructions executable by the processor, wherein the processor is configured to call instructions stored by the memory so as to perform the methods described above.

According to still another aspect of the present disclosure, there is provided a computer-readable storage medium storing computer program instructions which, when executed by a processor, implement the methods described above.

According to still another aspect of the present disclosure, there is provided a computer program comprising computer-readable codes, wherein when the codes run on an electronic apparatus, a processor in the electronic apparatus performs the methods described above.

In embodiments of the present disclosure, it is possible to acquire at least one of a backward propagation feature of the (x+1)th video frame and a forward propagation feature of the (x−1)th video frame, and thus possible to derive a reconstruction feature of the xth video frame from at least one of the xth video frame, the backward propagation feature of the (x+1)th video frame, and the forward propagation feature of the (x−1)th video frame. Further, it is possible to derive a target video frame corresponding to the xth video frame by reconstructing the xth video frame based on the reconstruction feature of the xth video frame, wherein the target video frame has resolution higher than that of the xth video frame. The image processing method and device, the electronic apparatus, and the storage medium provided by embodiments of the present disclosure reduces computation costs by deriving high-resolution images in higher reconstruction efficiency, and save plenty of feature extraction and aggregation time and improve reconstruction accuracy by making use of temporal continuity in natural videos by determining a reconstruction feature of a video frame from features transferred by a preceding video and a following video frame—that is, using features of proximate video frames without extracting features from scratch.

It should be appreciated that the foregoing general description and the following detailed description are exemplary and explanatory and not meant to limit the present disclosure. Other aspects of the present disclosure will become clear due to the following detailed explanations of exemplary embodiments with reference to the drawing.

### BRIEF DESCRIPTION OF THE DRAWINGS

The drawings, which are incorporated in and constitute part of the specification, illustrate embodiments in accordance with the present disclosure and serve to explain, together with the specification, technical solutions of the present disclosure.

FIG. 1 shows a flowchart of an image processing method according to an embodiment of the present disclosure;

FIG. 2 shows a schematic structural diagram of a neural network according to an embodiment of the present disclosure;

FIG. 3 shows a schematic diagram of an image processing method according to an embodiment of the present disclosure;

FIG. 4 shows a schematic diagram of an image processing method according to an embodiment of the present disclosure;

FIG. 5 shows a schematic diagram of an image processing method according to an embodiment of the present disclosure;

FIG. 6 shows a schematic diagram of an image processing method according to an embodiment of the present disclosure;

FIG. 7 shows a schematic diagram of an image processing method according to an embodiment of the present disclosure;

FIG. 8 shows a schematic diagram of an image processing method according to an embodiment of the present disclosure;

FIG. 9 shows a block diagram of an image processing device according to an embodiment of the present disclosure;

FIG. 10 shows a block diagram of an electronic apparatus 800 according to an embodiment of the present disclosure; and

FIG. 11 shows a block diagram of an electronic apparatus 1900 according to an embodiment of the present disclosure.

### DETAILED DESCRIPTION

Various exemplary embodiments, features, and aspects of the present disclosure will be described in detail with reference to the drawings. The same reference numerals in the drawings represent parts having the same or similar functions. Although various aspects of the embodiments are shown in the drawings, it is unnecessary to proportionally draw the drawings unless otherwise specified.

Herein the term “exemplary” means “used as an instance or example, or explanatory.” An “exemplary” embodiment given herein is not necessarily construed as being superior to or better than other embodiments.

The term “and/or” herein just means association between associated objects, which means that three relationships exist between the associated objects. For example, “A and/or B” means the three cases that A exists alone, A and B exist at the same time, and B exists alone. Besides, the term “at least one” herein means any one of a plurality things, or any combination of at least two of a plurality of things. For example, including at least one of A, B, and C means any one or some elements selected from the set consisting of A, B and C.

Numerous details are given in the following embodiments for the purpose of better explaining the present disclosure. It should be appreciated by a person skilled in the art that the present disclosure can still be implemented even without some of those details. In some of the embodiments, methods, means, units and circuits that are well known to a person skilled in the art are not described in detail so that the principle of the present disclosure become apparent.

FIG. 1 shows a flowchart of an image processing method according to an embodiment of the present disclosure. The method may be performed by an electronic apparatus such as a terminal apparatus or a server. The terminal apparatus may be user equipment (UE), a mobile apparatus, a terminal, a cellular phone, a cordless phone, a personal digital assistant (PDA), a handheld apparatus, a computing apparatus, an in-vehicle apparatus, a wearable apparatus, etc. The method may also be implemented by calling, by a processor, computer-readable instructions stored in a memory, or be performed by a server.

As shown in FIG. 1, the image processing method comprises the following:

Step S11 of acquiring at least one of a backward propagation feature of an (x+1)th video frame in a video segment and a forward propagation feature of an (x−1)th video frame in the video segment, wherein the video segment includes N video frames, N being an integer greater than 2, and x being an integer.

Video super-resolution is meant to reconstruct a high-resolution video corresponding to a given a low-resolution video. The image processing method provided by embodiments of the present disclosure can derive a corresponding high-resolution video by reconstructing a low-resolution video.

For example, video data to be processed can be regarded as one video segment, or be divided into multiple video segments which are independent of each other.

In a possible implementation, the method may further comprise:

determining at least two key frames in the video data; and

dividing the video data into at least one video segment based on the key frames.

For example, the first and last frames in the video data can be regarded as key frames, and the video data is regarded as one video segment. Alternatively, at least two key frames in the video data may be determined according to a preset number of interval frames. For example, the first frame in the video data is taken as a key frame, two adjacent key frames in the video data are spaced by a preset number of interval frames, and the video data is divided into multiple video segments based on every two adjacent key frames. Alternatively, the first frame in the video data is taken as a key frame, and for an Nth key frame, the optical flow between any frame that follows the Nth key frame and the Nth key frame is determined. If an average value of the optical flow is greater than a threshold, this frame is regarded as the (N+1)th key frame. Dividing the video data into multiple video segments based on every two adjacent key frames can ensure that video frames in the same video segment are correlated to each other to some extent.

In reconstructing a high-resolution image of the xth video frame in the video segment, a backward propagation feature of the (x+1)th video frame in the video segment, and/or a forward propagation feature of the (x−1)th video frame in the video segment can be acquired. A backward propagation feature of all video frames other than the first video frame (the second video frame, the third video frame, . . . , the (N−1)th video frame) in the video segment can be determined based on a backward propagation feature of a video frame that immediately follows a current video frame, and the determined backward propagation feature can be transferred to a video frame that immediately precedes the current video frame so that a backward propagation feature of the video frame that immediately precedes the current video frame can be determined based on a backward propagation feature of the current video frame. A forward propagation feature of all video frames other than the Nth video frame can be determined based on a forward propagation feature of a video frame that immediately precedes a current video frame, and the determined forward propagation feature can be transferred to a video frame that immediately follows the current video frame so that a forward propagation feature of the video frame that immediately follows the current video frame can be determined based on a forward propagation feature of the current video frame.

Step S12 of deriving a reconstruction feature of the xth video frame from at least one of the xth video frame, the backward propagation feature of the (x+1)th video frame, and the forward propagation feature of the (x−1)th video frame.

For example, after the backward propagation feature of the (x+1)th video frame, and/or the forward propagation feature of the (x−1)th video frame is/are acquired, a reconstruction feature of the xth video frame can be derived by performing feature extraction based on at least one of the xth video frame, the backward propagation feature of the (x+1)th video frame, and the forward propagation feature of the (x−1)th video frame. For instance, in the case of 1<x<N, a reconstruction feature of the xth video frame can be derived from the xth video frame, the backward propagation feature of the (x+1)th video frame, and the forward propagation feature of the (x−1)th video frame. In the case of x=1, a reconstruction feature of the xth video frame can be derived from the xth video frame or the backward propagation feature of the (x+1)th video frame. In the case of x=N, a reconstruction feature of the xth video frame can be derived from the xth video frame or the forward propagation feature of the (x−1)th video frame. For instance, a reconstruction feature of the xth video frame can be derived by performing, by means of a neural network configured to extract a reconstruction feature, convolution on at least one of the xth video frame, the backward propagation feature of the (x+1)th video frame, and the forward propagation feature of the (x−1)th video frame.

Step S13 of deriving a target video frame corresponding to the xth video frame by reconstructing the xth video frame based on the reconstruction feature of the xth video frame, wherein the target video frame has resolution higher than that of the xth video frame.

For example, a high-resolution reconstruction feature can be derived by amplifying the reconstruction feature of the xth video frame by means of convolution and multi-channel recombination. Then, a target video frame corresponding to the xth video frame is derived by performing up-sampling on the x-th video frame to derive an up-sampling result, and adding the high-resolution reconstruction feature and the up-sampling result. The target video frame has resolution higher than that of the xth video frame, that is, the target video frame is a high-resolution image frame of the xth video frame.

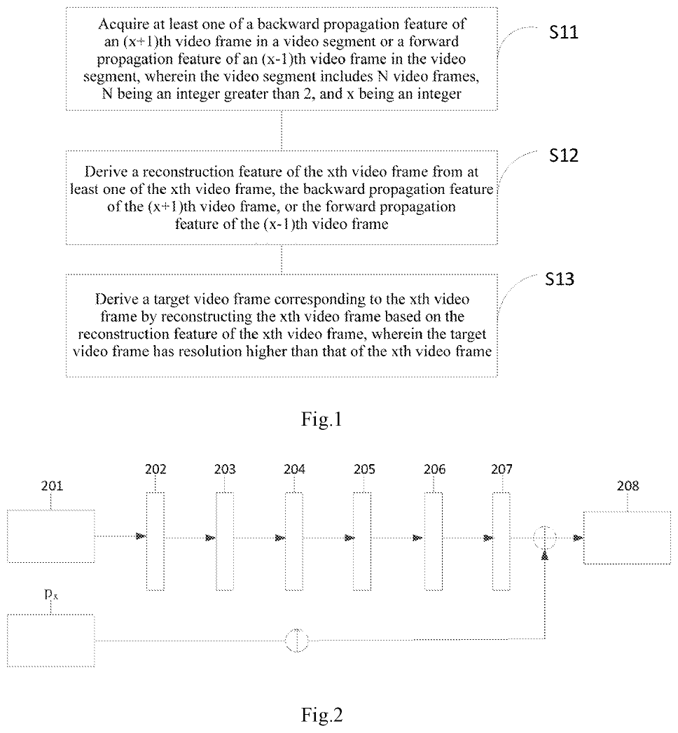

Illustratively, FIG. 2 shows a schematic structural diagram of a neural network configured to reconstruct a high-resolution image. A convolution module 202 performs convolution on a reconstruction feature 201 of the xth video frame (pₓ) to give a convolution result. A pixel recombination module 203 processes the convolution result to give a first processing result, which is then subjected to processing by a convolution module 204 and a pixel recombination module 205 to give a second processing result. A convolution module 206 and a convolution module 207 perform convolution twice on the second processing result to give an amplified reconstruction feature. The xth video frame (pₓ) is subjected to up-sampling to give an up-sampling result. Adding the up-sampling result and the amplified reconstruction feature together results in a target video frame 208 corresponding to the xth video frame.

In this way, it is possible to acquire at least one of a backward propagation feature of the (x+1)th video frame and a forward propagation feature of the (x−1)th video frame, and thus possible to derive a reconstruction feature of the xth video frame from at least one of the xth video frame, the backward propagation feature of the (x+1)th video frame, and the forward propagation feature of the (x−1)th video frame. Further, it is possible to derive a target video frame corresponding to the xth video frame by reconstructing the xth video frame based on the reconstruction feature of the xth video frame, wherein the target video frame has resolution higher than that of the xth video frame. The image processing method provided by an embodiment of the present disclosure improves the reconstruction efficiency of high-resolution images, reduces computation costs, saves plenty of feature extraction and aggregation time, and improves reconstruction accuracy by making use of temporal continuity in natural videos by determining a reconstruction feature of any video frame from features transferred by a preceding video frame and a following video frame—that is, using features of proximate video frames without extracting features from scratch.

In a possible implementation, deriving a reconstruction feature of the xth video frame from at least one of the xth video frame, a backward propagation feature of the (x+1)th video frame, and a forward propagation feature of the (x−1)th video frame may comprise:

determining a backward propagation feature of the xth video frame based on the xth video frame, the (x+1)th video frame, and the backward propagation feature of the (x+1)th video frame;

determining a forward propagation feature of the xth video frame based on the xth video frame, the (x−1)th video frame, the forward propagation feature of the (x−1)th video frame, and the backward propagation feature of the xth video frame; and

using the forward propagation feature of the xth video frame as a reconstruction feature of the xth video frame.

For example, a backward propagation feature of the xth video frame can be derived by distorting the backward propagation feature of the (x+1)th video frame by means of the xth video frame and the (x+1)th video frame to achieve feature alignment.

In a possible implementation, determining a backward propagation feature of the xth video frame based on the xth video frame, the (x+1)th video frame, and the backward propagation feature of the (x+1)th video frame may comprise:

deriving a first optical flow diagram from the xth video frame and the (x+1)th video frame;

deriving a distorted backward propagation feature by distorting the backward propagation feature of the (x+1)th video frame based on the first optical flow diagram; and

deriving a backward propagation feature of the xth video frame from the distorted backward propagation feature and the xth video frame.

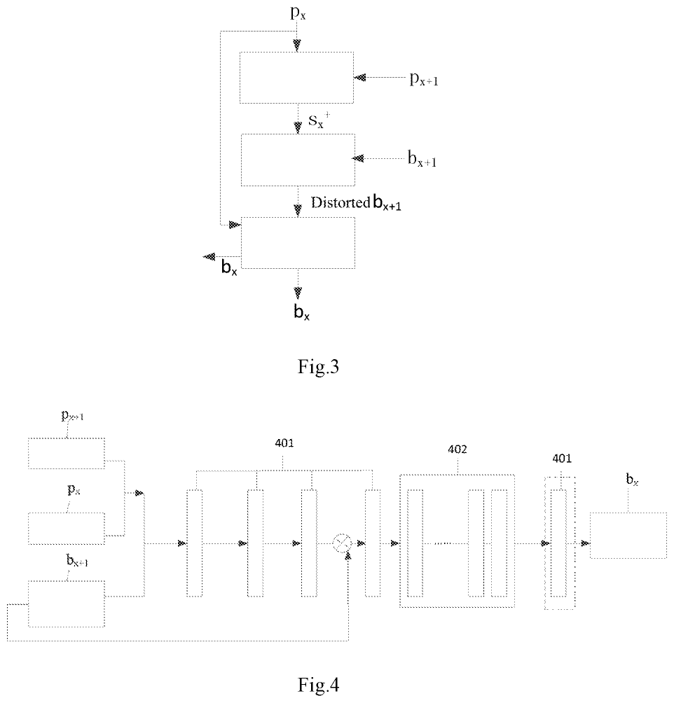

For example, as shown in FIG. 3, it is possible to predict a first optical flow diagram (denoted by sₓ⁺ in FIG. 3) between the xth video frame (denoted by pₓ in FIG. 3) and the (x+1)th video frame (denoted by pₓ₊₁ in FIG. 3) from the xth video frame and the (x+1)th video frame, derive a distorted backward propagation feature by feature aligning the backward propagation feature (denoted by bₓ₊₁ in FIG. 3) of the (x+1)th video frame with the xth video frame based on the first optical flow diagram sₓ⁺, and derive a backward propagation feature (denoted by bₓ in FIG. 3) of the xth video frame from the distorted backward propagation feature and the xth video frame.

Illustratively, a backward propagation feature of the xth video frame (denoted by pₓ) can be determined using a neural network configured to determine a backward propagation feature shown in FIG. 4, in which 401 denotes a convolution module, and 402 denotes a residual module. To be specific, the first step is to derive a distorted backward propagation feature by distorting the backward propagation feature bₓ₊₁ of the (x+1)th video frame by means of a first optical flow diagram between the xth video frame and the (x+1)th video frame to construct correspondence between the xth video frame and the backward propagation feature bₓ₊₁ of the (x+1)th video frame. The next step is to derive a backward propagation feature bₓ of the xth video frame by performing convolution a number of times on the distorted backward propagation feature and the xth video frame and using the convolution result as input of the residual module.

Subsequent to deriving the backward propagation feature bₓ of the xth video frame, a forward propagation feature of the xth video frame can be determined based on the backward propagation feature bₓ of the xth video frame.

In a possible implementation, determining a forward propagation feature of the xth video frame based on the xth video frame, the (x−1)th video frame, the forward propagation feature of the (x−1)th video frame, and the backward propagation feature of the xth video frame may comprise:

deriving a second optical flow diagram from the xth video frame and the (x−1)th video frame;

deriving a distorted forward propagation feature by distorting the forward propagation feature of the (x−1)th video frame based on the second optical flow diagram; and

deriving a forward propagation feature of the xth video frame from the backward propagation feature of the xth video frame, the distorted forward propagation feature, and the xth video frame.

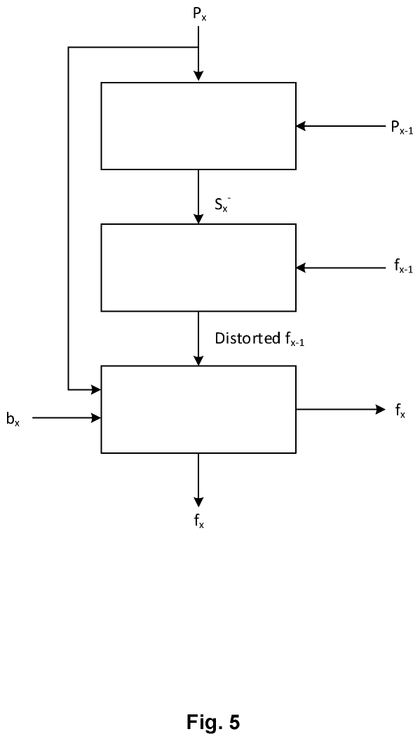

For example, as shown in FIG. 5, it is possible to predict a second optical flow diagram (denoted by sₓ′ in FIG. 5) between the xth video frame (denoted by pₓ in FIG. 5) and the (x−1)th video frame (denoted by pₓ₋₁ in FIG. 5) from the xth video frame and the (x−1)th video frame, derive a distorted forward propagation feature by feature aligning the forward propagation feature (denoted by fₓ₋₁ in FIG. 5) of the (x−1)th video frame with the xth video frame based on the second optical flow diagram sₓ⁺, and derive a forward propagation feature (denoted by fₓ in FIG. 5) of the xth video frame from the distorted forward propagation feature, the backward propagation feature of the xth video frame, and the xth video frame.

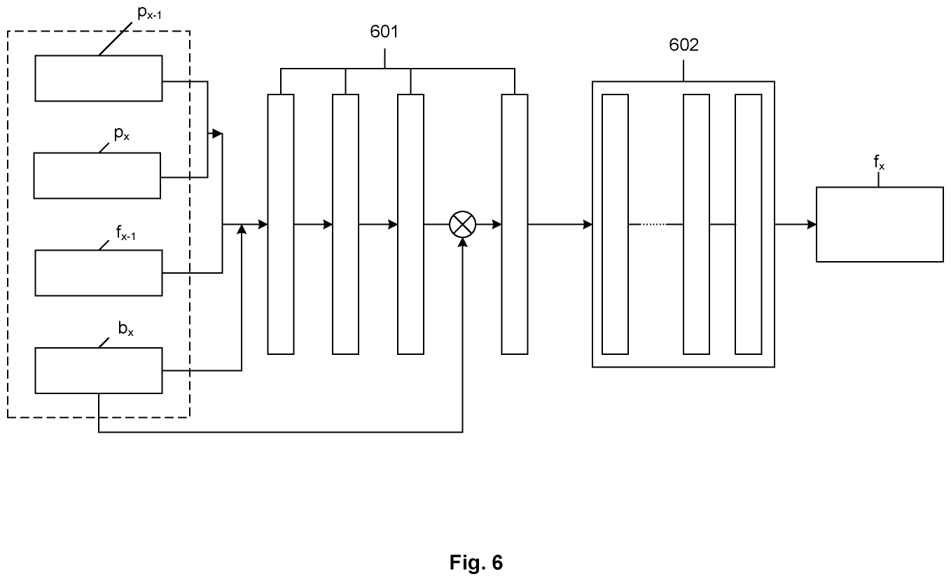

Illustratively, a forward propagation feature of the xth video frame can be determined using a neural network configured to determine a forward propagation feature shown in FIG. 6, in which 601 denotes a convolution module, and 602 denotes a residual module. To be specific, the first step is to derive a distorted forward propagation feature by distorting the forward propagation feature fₓ₋₁ of the (x−1)th video frame by means of a second optical flow diagram between the xth video frame and the (x−1)th video frame to construct correspondence between the xth video frame and the forward propagation feature fₓ₋₁ of the (x−1)th video frame. The next step is to derive a forward propagation feature fₓ of the xth video frame by performing convolution a number of times on the distorted forward propagation feature, the backward propagation feature of the xth video frame, and the xth video frame and using the convolution result as input of the residual module.

In a possible implementation, in the case of x=1, deriving a reconstruction feature of the xth video frame from at least one of the xth video frame, the backward propagation feature of the (x+1)th video frame, and the forward propagation feature of the (x−1)th video frame may comprise:

deriving a forward propagation feature of the xth video frame by performing feature extraction on the xth video frame; and

using the forward propagation feature of the xth video frame as a reconstruction feature of the xth video frame.

For instance, feature extraction can be performed on a first video frame and optional neighboring frames (a preset number of video frames that are sequentially associated with the first video frame), and the extracted feature is transferred as a forward propagation feature of the first video frame to a second video frame. Doing so allows for predicting a forward propagation feature of the second video frame from the forward propagation feature of the first video frame, and transferring it to a third video frame . . . , until a forward propagation feature of a (N−2)th video frame is predicted based on the forward propagation feature of a (N−1)th video frame. Embodiments of the present disclosure are not meant to limit how to extract a feature from a video frame, and any method capable of image feature extraction is acceptable.

After the forward propagation feature of the first video frame is extracted, it can be used as a reconstruction feature of the first video frame, and then a high-resolution image reconstruction on the first video frame can be performed based on the reconstruction feature of the first video frame, thereby deriving a target video frame corresponding to the first video frame. The target video frame is the high-resolution image of the first video frame. Embodiments of the present disclosure are not meant to limit how to perform image reconstruction on the first video frame, and consulting relevant techniques will work.

In a possible implementation, in the case of x=N, deriving a reconstruction feature of the xth video frame from at least one of the xth video frame, the backward propagation feature of the (x+1)th video frame, and the forward propagation feature of the (x−1)th video frame may comprise:

deriving a backward propagation feature of the xth video frame by performing feature extraction on the xth video frame; and

using the backward propagation feature of the xth video frame as a reconstruction feature of the xth video frame.

For instance, a feature can be extracted from an Nth video frame and optional neighboring frames (a preset number of video frames that are sequentially associated with the Nth video frame), and the extracted feature is transferred as a backward propagation feature of the Nth video frame to the (N−1)th video frame. Doing so allows for predicting a backward propagation feature of the (N−1)th video frame from the forward propagation feature of the Nth video frame, and transferring it to the (N−2)th video frame . . . , until a backward propagation feature of the second video frame is predicted from the backward propagation feature of the third video frame. Embodiments of the present disclosure are not meant to limit how to extract a feature from a video frame, and any method capable of image feature extraction is acceptable.

After the forward propagation feature of the Nth video frame is extracted, the backward propagation feature of the Nth video frame can be used as a reconstruction feature of the Nth video frame, and then a high-resolution image reconstruction on the Nth video frame can be performed based on the reconstruction feature of the Nth video frame, thereby deriving a target video frame corresponding to the Nth video frame. The target video frame is the high-resolution image of the Nth video frame. Embodiments of the present disclosure are not meant to limit how to perform image reconstruction on the Nth video frame, and consulting relevant techniques will work.

In this way, embodiments of the present disclosure allows for high-resolution reconstruction of all video frames in a video segment by performing feature extraction only on the first video frame and the Nth video frame in the video segment, thereby making reconstruction of high-resolution images more efficient and reducing the computation costs.

In a possible implementation, in the case of x=1, deriving a reconstruction feature of the xth video frame from at least one of the xth video frame, the backward propagation feature of the (x+1)th video frame, and the forward propagation feature of the (x−1)th video frame may comprise:

acquiring a backward propagation feature of the (x+1)th video frame for the xth video frame;

deriving a forward propagation feature of the xth video frame from the xth video frame and the backward propagation feature of the (x+1)th video frame; and

using the forward propagation feature of the xth video frame as a reconstruction feature of the xth video frame.

For example, a backward propagation feature of the second video frame can be determined using a neural network configured to determine a backward propagation feature shown in FIG. 4. The first step is to acquire a backward propagation feature of the second video frame and derive a distorted backward propagation feature by distorting the backward propagation feature of the second video frame by means of an optical flow diagram between the first video frame and the second video frame to construct correspondence between the first video frame and the backward propagation feature of the second video frame. The next step is to derive a forward propagation feature of the first video frame by performing convolution a number of times on the distorted backward propagation feature and the first video frame and using the convolution result as input of the residual module. The further step is to transfer the forward propagation feature as a reconstruction feature of the first video frame to the second video frame, predict a forward propagation feature of the second video frame from the forward propagation feature of the first video frame, and transfer the forward propagation feature of the second video frame to the third video frame . . . until a backward propagation feature of the Nth video frame is predicted from the forward propagation feature of the (N−1)th video frame.

After the reconstruction feature of the first video frame is determined, the target video frame of the first video frame can be reconstructed using a neural network configured to reconstruct a high-resolution image as shown in FIG. 2.

In a possible implementation, in the case of x=N, deriving a reconstruction feature of the xth video frame from at least one of the xth video frame, the backward propagation feature of the (x+1)th video frame, and the forward propagation feature of the (x−1)th video frame may comprise:

acquiring a forward propagation feature of the (x−1)th video frame for the xth video frame;

deriving a backward propagation feature of the xth video frame from the xth video frame and the forward propagation feature of the (x−1)th video frame; and

using the backward propagation feature of the xth video frame as a reconstruction feature of the xth video frame.

For example, the first step is to acquire a forward propagation feature of the (N−1)th video frame and derive a distorted forward propagation feature by distorting the forward propagation feature of the (N−1)th video frame by means of an optical flow diagram between the Nth video frame and the (N−1)th video frame to construct correspondence between the Nth video frame and the forward propagation feature of the (N−1)th video frame. The next step is to derive a backward propagation feature of the Nth video frame by performing convolution a number of times on the distorted forward propagation feature and the Nth video frame and using the convolution result as input of the residual module. The further step is to transfer the backward propagation feature as a reconstruction feature of the Nth video frame to the (N−1)th video frame, predict a backward propagation feature of the (N−1)th video frame from the backward propagation feature of the Nth video frame, and transfer the backward propagation feature of the (N−1)th video frame to the (N−2)th video frame . . . until a forward propagation feature of the first video frame is predicted from the backward propagation feature of the second video frame.

After the reconstruction feature of the first video frame is determined, the target video frame of the first video frame can be reconstructed using a neural network configured to reconstruct a high-resolution image as shown in FIG. 2.

In this way, embodiments of the present disclosure allow for high-resolution reconstruction of all video frames in a video segment without extracting a feature from any one of the video frames in the video segment, thereby making reconstruction of high-resolution images more efficient and reducing the computation costs.

In order for a person skilled in the art to better understand embodiments of the present disclosure, the following is an explanation of embodiments of the present disclosure by means of examples.

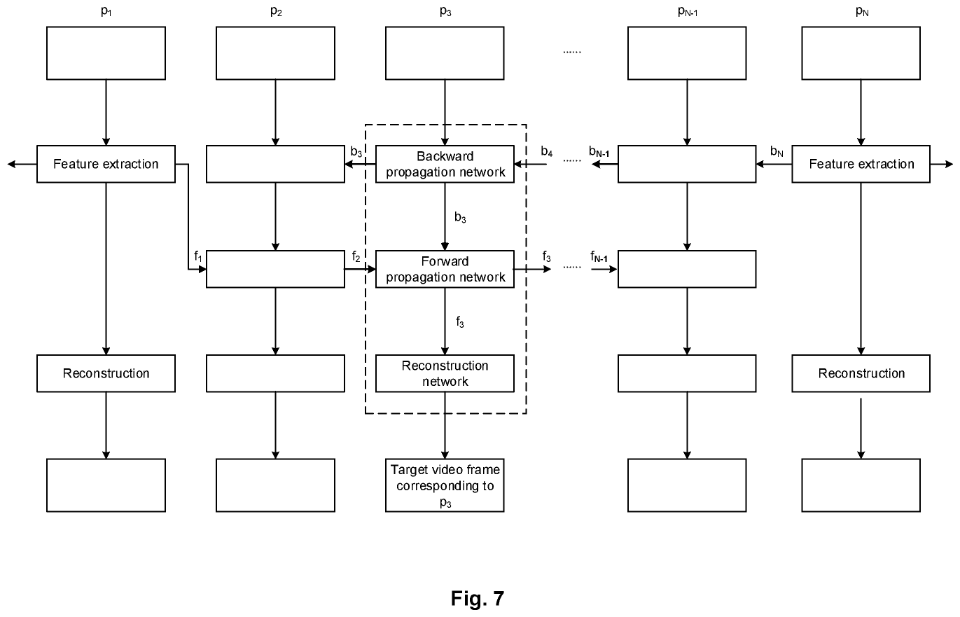

As shown in FIG. 7, for the video segment S (p₁ to p_{N}), the processing is to derive a backward propagation feature of the Nth video frame by performing feature extraction on the Nth video frame, reconstruct a high-resolution image of the Nth video frame based on the backward propagation feature, transfer the backward propagation feature to the (N−1)th video frame to predict a backward propagation feature of the (N−1)th video frame from the backward propagation feature of the Nth video frame, and transfer the backward propagation feature of the (N−1)th video frame to the (N−2)th video frame . . . until a backward propagation feature of the second video frame is predicted from the backward propagation feature of the second video frame. That is, the backward propagation feature of every video frame in the video segment (p₂ to p_{N}1) can be predicted from the backward propagation feature of a following video frame in the video segment (p₂ to p_{N-1}).

The processing is to derive a forward propagation feature of the first video frame by performing feature extraction on the first video frame, derive the target video corresponding to the first video frame by reconstructing a high-resolution image of the first video frame based on the forward propagation feature, transfer the forward propagation feature of the first video frame to the second video frame to predict a forward propagation feature of the second video frame from the backward propagation feature of the second video frame and the forward propagation feature of the first video frame, derive the target video frame corresponding to the second video frame by reconstructing the second video frame by means of using the forward propagation feature of the second video as the reconstruction feature, transfer the forward propagation feature of the second video frame to the third video frame . . . until a forward propagation feature of the (N−1)th video frame is predicted from the forward propagation feature of the (N−2)th video frame, and derive the target video frame corresponding to the (N−1)th video frame by reconstructing the (N−1)th video frame by means of using the forward propagation feature of the (N−1)th video as the reconstruction feature. That is, the forward propagation feature of every video frame in the video segment (p₂ to p_{N-1}) can be predicted from the forward propagation feature of a preceding video frame in the video segment (p₂ to p_{N-1}), and a corresponding target video frame is derived through reconstruction based on the forward propagation feature.

In a possible implementation, deriving a reconstruction feature of the xth video frame from at least one of the xth video frame, the backward propagation feature of the (x+1)th video frame, and the forward propagation feature of the (x−1)th video frame may comprise:

determining a forward propagation feature of the xth video frame based on the xth video frame, the (x−1)th video frame, and the forward propagation feature of the (x−1)th video frame;

determining a backward propagation feature of the xth video frame based on the xth video frame, the (x+1)th video frame, the backward propagation feature of the (x+1)th video frame, and the forward propagation feature of the xth video frame; and

using the backward propagation feature of the xth video frame as a reconstruction feature of the xth video frame.

For example, a backward propagation feature of the xth video frame can be derived by distorting the forward propagation feature of the (x−1)th video frame by means of the xth video frame and the (x−1)th video frame to achieve feature alignment.

In a possible implementation, determining a forward propagation feature of the xth video frame based on the xth video frame, the (x−1)th video frame, and the forward propagation feature of the (x−1)th video frame, may comprise:

deriving a second optical flow diagram from the xth video frame and the (x−1)th video frame;

deriving a distorted forward propagation feature by distorting the forward propagation feature of the (x−1)th video frame based on the second optical flow diagram; and

deriving a forward propagation feature of the xth video frame from the distorted forward propagation feature and the xth video frame.

For example, the processing is to predict a second optical flow diagram between the xth video frame and the (x−1)th video frame from the xth video frame and the (x−1)th video frame, derive a distorted forward propagation feature by feature aligning the forward propagation feature of the (x−1)th video frame with the xth video frame based on the second optical flow diagram to construct correspondence between the xth video frame and the forward propagation feature of the (x−1)th video frame, and further derive a forward propagation feature of the xth video frame from the distorted forward propagation feature and the xth video frame. As an example, a forward propagation feature of the xth video frame can be derived by performing convolution a number of times on the distorted forward propagation feature and the xth video frame and using the convolution result as input of the residual module.

After the forward propagation feature of the xth video frame is acquired, a backward propagation feature of the xth video frame can be determined from its forward propagation feature.

In a possible implementation, determining a backward propagation feature of the xth video frame based on the xth video frame, the (x+1)th video frame, the backward propagation feature of the (x+1)th video frame, and the forward propagation feature of the xth video frame may comprise:

deriving a first optical flow diagram from the xth video frame and the (x+1)th video frame;

deriving a distorted backward propagation feature by distorting the backward propagation feature of the (x+1)th video frame based on the first optical flow diagram; and

deriving a backward propagation feature of the xth video frame from the forward propagation feature of the xth video frame, the distorted backward propagation feature, and the xth video frame.

For example, the processing may be to predict a first optical flow diagram between the xth video frame and the (x+1)th video frame from the xth video frame and the (x+1)th video frame, derive a distorted forward propagation feature by feature aligning the backward propagation feature of the (x+1)th video frame with the xth video frame based on the second optical flow diagram to construct correspondence between the xth video frame and the backward propagation feature of the (x+1)th video frame, and further derive a backward propagation feature of the xth video frame from the distorted backward propagation feature, the forward propagation feature of the xth video frame, and the xth video frame. As an example, a backward propagation feature of the xth video frame can be derived by performing convolution a number of times on the distorted backward propagation feature, the forward propagation feature of the xth video frame, and the xth video frame and using the convolution result as input of the residual module.

In order for a person skilled in the art to better understand embodiments of the present disclosure, the following is an explanation of embodiments of the present disclosure by means of examples.

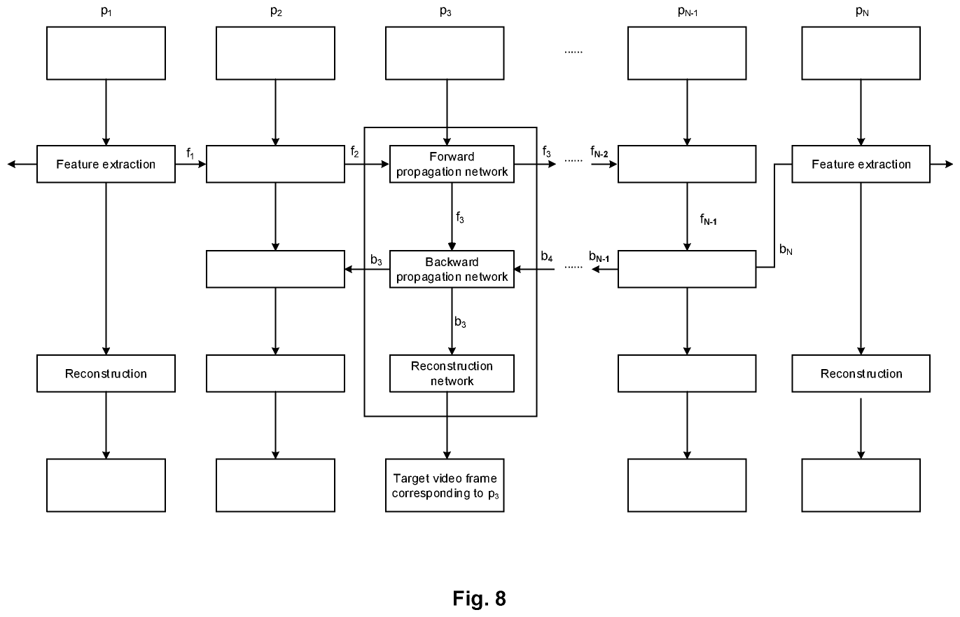

As shown in FIG. 8, for the video segment S (p₁ to p_{N}), the processing is to derive a forward propagation feature of the first video frame by performing feature extraction on the first video frame, reconstruct a high-resolution image of the first video frame based on the forward propagation feature, transfer the forward propagation feature to the second video frame to predict a forward propagation feature of the second video frame from the forward propagation feature of the first video frame, and transfer the forward propagation feature of the second video frame to the third video frame . . . until a forward propagation feature of the (N−1)th video frame is predicted from the forward propagation feature of the (N−2)th video frame. That is, it is possible to predict the forward propagation feature of every video frame in the video segment (p₂ to p_{N-1}) from the forward propagation feature of a preceding video frame in the video segment (p₂ to p_{N-1}).

The processing is to derive a backward propagation feature of the Nth video frame by performing feature extraction on the Nth video frame, derive the target video corresponding to the Nth video frame by reconstructing a high-resolution image of the Nth video frame based on the backward propagation feature, transfer the backward propagation feature of the Nth video frame to the (N−1)th video frame to predict a backward propagation feature of the (N−1)th video frame from the forward propagation feature of the (N−1)th video frame and the backward propagation feature of the Nth video frame, derive the target video frame corresponding to the (N−1)th video frame by reconstructing the (N−1)th video frame by means of using the backward propagation feature of the (N−1)th video as the reconstruction feature, transfer the backward propagation feature of the (N−1)th video frame to the (N−2)th video frame . . . until a backward propagation feature of the second video frame is predicted from the backward propagation feature of the third video frame, and derive the target video frame corresponding to the second video frame by reconstructing the second video frame by means of using the backward propagation feature of the second video as the reconstruction feature. That is, it is possible to predict the backward propagation feature of every video frame in the video segment (p₂ to p_{N-1}) from the backward propagation feature of a following video frame the video segment (p₂ to p_{N-1}) and derive a corresponding target video frame through reconstruction based on the backward propagation feature.

It can be appreciated that the various method embodiments mentioned above in the present disclosure may all be combined, without departing from principles and logics, with each other to form a combined embodiment. In this regard, no more detail is given herein. It can be appreciated by a person skilled in the art that in the methods described in the above embodiments, the order of carrying out the steps should be determined by their functions and logic.

The present disclosure further provides an image processing device, an electronic apparatus, a computer-readable storage medium, and a program that are capable of implementing any of the image processing methods provided by the present disclosure. For details of the image processing device, electronic apparatus, computer-readable storage medium, and program, see the foregoing description of the methods.

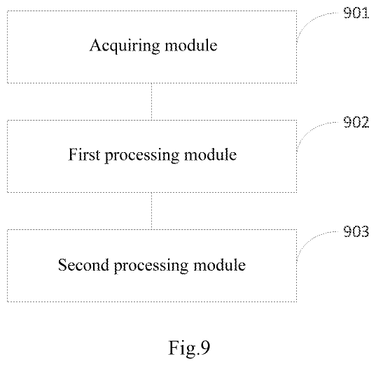

FIG. 9 shows a block diagram of an image processing device according to an embodiment of the present disclosure. As shown in FIG. 9, the image processing device comprises:

an acquiring module 901 configured to acquire at least one of a backward propagation feature of an (x+1)th video frame in a video segment and a forward propagation feature of an (x−1)th video frame in the video segment, wherein the video segment includes N video frames, N being an integer greater than 2, and x being an integer;

a first processing module 902 configured to derive a reconstruction feature of the xth video frame from at least one of the xth video frame, the backward propagation feature of the (x+1)th video frame, and the forward propagation feature of the (x−1)th video frame; and

a second processing module 903 configured to derive a target video frame corresponding to the xth video frame by reconstructing the xth video frame based on the reconstruction feature of the xth video frame, wherein the target video frame has resolution higher than that of the xth video frame.

In some embodiments of the present disclosure, the functions possessed or modules contained by the device provided by embodiments of the present disclosure can be used to perform the methods described in the above method embodiments. For implementation and technical effects of the device, see the foregoing description of the method embodiments, and no more detail is given herein for conciseness sake.

In a possible implementation, in the case of 1<x<N, the first processing module may further be configured to determine a backward propagation feature of the xth video frame based on the xth video frame, the (x+1)th video frame, and the backward propagation feature of the (x+1)th video frame;

determine a forward propagation feature of the xth video frame based on the xth video frame, the (x−1)th video frame, the forward propagation feature of the (x−1)th video frame, and the backward propagation feature of the xth video frame; and

use the forward propagation feature of the xth video frame as a reconstruction feature of the xth video frame.

In a possible implementation, the first processing module may further be configured to derive a first optical flow diagram from the xth video frame and the (x+1)th video frame;

derive a distorted backward propagation feature by distorting the backward propagation feature of the (x+1)th video frame based on the first optical flow diagram; and

derive a backward propagation feature of the xth video frame from the distorted backward propagation feature and the xth video frame.

In a possible implementation, the first processing module may further be configured to derive a second optical flow diagram from the xth video frame and the (x−1)th video frame;

derive a distorted forward propagation feature by distorting the forward propagation feature of the (x−1)th video frame based on the second optical flow diagram; and

derive a forward propagation feature of the xth video frame from the backward propagation feature of the xth video frame, the distorted forward propagation feature, and the xth video frame.

In a possible implementation, in the case of 1<x<N, the first processing module may further be configured to determine a forward propagation feature of the xth video frame based on the xth video frame, the (x−1)th video frame, and the forward propagation feature of the (x−1)th video frame;

determine a backward propagation feature of the xth video frame based on the xth video frame, the (x+1)th video frame, the backward propagation feature of the (x+1)th video frame, and the forward propagation feature of the xth video frame; and

use the backward propagation feature of the xth video frame as a reconstruction feature of the xth video frame.

In a possible implementation, the first processing module may further be configured to derive a second optical flow diagram from the xth video frame and the (x−1)th video frame;

derive a distorted forward propagation feature by distorting the forward propagation feature of the (x−1)th video frame based on the second optical flow diagram; and

derive a forward propagation feature of the xth video frame from the distorted forward propagation feature and the xth video frame.

In a possible implementation, the first processing module may further be configured to derive a first optical flow diagram from the xth video frame and the (x+1)th video frame;

derive a distorted backward propagation feature by distorting the backward propagation feature of the (x+1)th video frame based on the first optical flow diagram; and

derive a backward propagation feature of the xth video frame from the forward propagation feature of the xth video frame, the distorted backward propagation feature, and the xth video frame.

In a possible implementation, in the case of x=1, the first processing module may further be configured to:

derive a forward propagation feature of the xth video frame by performing feature extraction on the xth video frame; and

use the forward propagation feature of the xth video frame as a reconstruction feature of the xth video frame.

In a possible implementation, in the case of x=N, the first processing module may further be configured to:

acquire a backward propagation feature of the xth video frame by performing feature extraction on the xth video frame; and

use the backward propagation feature of the xth video frame as a reconstruction feature of the xth video frame.

In a possible implementation, in the case of x=1, the first processing module may further be configured to:

acquire a backward propagation feature of the (x+1)th video frame for the xth video frame;

derive a forward propagation feature of the xth video frame from the xth video frame and the backward propagation feature of the (x+1)th video frame; and

use the forward propagation feature of the xth video frame as a reconstruction feature of the xth video frame.

In a possible implementation, in the case of x=N, the first processing module may further be configured to:

acquire a forward propagation feature of the (x−1)th video frame for the xth video frame;

derive a backward propagation feature of the xth video frame from the xth video frame and the forward propagation feature of the (x−1)th video frame; and

use the backward propagation feature of the xth video frame as a reconstruction feature of the xth video frame.

In a possible implementation, the device may comprise:

a determining module configured to determine at least two key frames in video data; and

a dividing module configured to divide the video data into at least one video segment based on the key frames.

In some embodiments of the present disclosure, the functions possessed or modules contained by the device provided by embodiments of the present disclosure can be used to perform the methods described in the above method embodiments. For implementation of the device, see the foregoing description of the method embodiments, and no more detail is given herein for conciseness sake.

Embodiments of the present disclosure further provide a computer-readable storage medium storing computer program instructions which, when executed by a processor, implement the methods described above. The computer-readable storage medium may be a non-volatile computer-readable storage medium.

Embodiments of the present disclosure further provide an electronic apparatus comprising a processor; and a memory for storing instructions executable by the processor, wherein the processor is configured to call instructions stored by the memory so as to perform the methods described above.

Embodiments of the present disclosure further provide a computer program product comprising computer-readable codes, wherein when the codes run on an apparatus, a processor in the apparatus executes instructions for implementing the image processing method provided by any one of the embodiments described above.

Embodiments of the present disclosure also provide another computer program product for storing computer-readable instructions which, when executed, causes a computer to perform an operation of the image processing method provided by any one of the embodiments described above.

Embodiments of the present disclosure also provide a computer program comprising computer-readable codes, wherein when the codes run on an electronic apparatus, a processor in the electronic apparatus performs the image processing methods described above.

The electronic apparatus may be provided as a terminal, a server, or an apparatus in a different form.

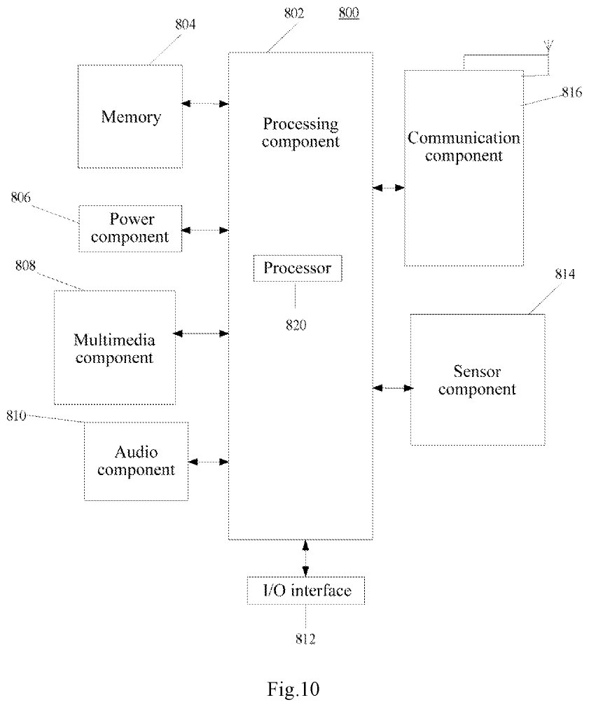

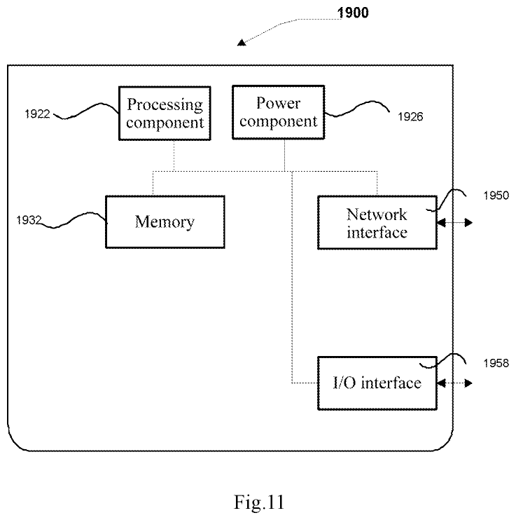

FIG. 10 is a block diagram of electronic apparatus 800 according to an embodiment of the present disclosure. For example, electronic apparatus 800 may be a mobile phone, a computer, a digital broadcasting terminal, a messaging device, a game console, a tablet device, medical equipment, fitness equipment, a personal digital assistant, and the like.

Referring to FIG. 10, electronic apparatus 800 includes one or more of processing component 802, memory 804, power component 806, multimedia component 808, audio component 810, input/output (I/O) interface 812, sensor component 814, and communication component 816.

Processing component 802 is to control overall operations of electronic apparatus 800, such as the operations associated with display, telephone calls, data communications, camera operations, and recording operations. Processing component 802 can include one or more processors 820 configured to execute instructions to perform all or part of the steps included in the methods described above. Processing component 802 may include one or more modules configured to facilitate the interaction between the processing component 802 and other components. For example, processing component 802 may include a multimedia module configured to facilitate the interaction between multimedia component 808 and processing component 802.

Memory 804 is configured to store various types of data to support the operation of electronic apparatus 800. Examples of such data include instructions for any applications or methods operated on or performed by electronic apparatus 800, contact data, phonebook data, messages, pictures, video, etc. In an embodiment of the present disclosure, memory 804 may be used to store data blocks, mappings, or other things retrieved from a distributed system. Memory 804 may be implemented using any type of volatile or non-transitory memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 is configured to provide power to various components of electronic apparatus 800. Power component 806 may include a power management system, one or more power sources, and any other components associated with the generation, management, and distribution of power in electronic apparatus 800.

Multimedia component 808 includes a screen providing an output interface between electronic apparatus 800 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe operation, but also a period of time and a pressure associated with the touch or swipe operation. In some embodiments, multimedia component 808 may include a front camera and/or a rear camera. The front camera and the rear camera may receive an external multimedia datum while electronic apparatus 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 may include a microphone (MIC) configured to receive an external audio signal when electronic apparatus 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 may include one or more sensors configured to provide status assessments of various aspects of electronic apparatus 800. For example, sensor component 814 may detect an open/closed status of electronic apparatus 800, relative positioning of components which are e.g., the display and the keypad of electronic apparatus 800, a change in position of electronic apparatus 800 or a component of electronic apparatus 800, a presence or absence of user contact with electronic apparatus 800, an orientation or an acceleration/deceleration of electronic apparatus 800, and a change in temperature of electronic apparatus 800. Sensor component 814 may include a proximity sensor configured to detect the presence of nearby objects without any physical contact. Sensor component 814 may also include a light sensor, such as a complementary metal oxide semiconductor (CMOS) or charge-coupled device (CCD) image sensor, for use in imaging applications. In some embodiments, sensor component 814 may also include an accelerometer sensor, a gyroscope sensor, a magnetic sensor, a pressure sensor, or a temperature sensor.

Communication component 816 is configured to facilitate wired or wireless communication between electronic apparatus 800 and other devices. Electronic apparatus 800 can access a wireless network based on a communication standard, such as WiFi, 2G, or 3G, 4G, or a combination thereof. In an exemplary embodiment, communication component 816 receives a broadcast signal or broadcast associated information from an external broadcast management system via a broadcast channel. In an exemplary embodiment, communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In an exemplary embodiment, electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the methods described above.

In an exemplary embodiment, there is also provided a non-transitory computer readable storage medium such as memory 804 storing instructions executable by processor 820 of electronic apparatus 800, for performing the methods described above.

FIG. 11 is a block diagram of electronic apparatus 1900 according to an example of the present disclosure. For example, electronic apparatus 1900 may be provided as a server. Referring to FIG. 11, electronic apparatus 1900 includes processing component 1922, which further includes one or more processors, and a memory resource represented by memory 1932 configured to store instructions such as application programs executable for processing component 1922. The application programs stored in memory 1932 may include one or more than one module of which each corresponds to a set of instructions. In addition, processing component 1922 is configured to execute the instructions to execute the abovementioned methods.

Electronic apparatus 1900 may further include power component 1926 configured to execute power management of electronic apparatus 1900, wired or wireless network interface 1950 configured to connect electronic apparatus 1900 to a network, Input/Output (I/O) interface 1958. Electronic apparatus 1900 may be operated on the basis of an operating system stored in the memory 1932, such as Windows Server™, Mac OS X™, Unix™, Linux™ or FreeBSD™.

In an exemplary embodiment, there is also provided a non-transitory computer readable storage medium such as memory 1932 storing instructions executable by processing component 1922 of apparatus 1900, for performing the methods described above.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible apparatus that can retain and store instructions for use by an instruction execution apparatus. The computer readable storage medium may be, for example, but is not limited to, an electronic storage apparatus, a magnetic storage apparatus, an optical storage apparatus, an electromagnetic storage apparatus, a semiconductor storage apparatus, or any suitable combination of the foregoing. A non-exhaustive list of more specific examples of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing apparatus from a computer readable storage medium or to an external computer or external storage apparatus via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing apparatus.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry such as programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, device (systems), and computer program products according to examples of the present disclosure. It can be appreciated that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/operations specified in the flowchart and/or block diagram block or blocks. These computer readable program instructions may also be stored in a computer readable storage medium that can direct a computer, a programmable data processing device, and/or other apparatuses to function in a particular manner, such that the computer readable storage medium having instructions stored therein comprises an article of manufacture including instructions which implement aspects of the functions/operations specified in the flowchart and/or block diagram block or blocks.

The computer readable program instructions may also be loaded onto a computer, other programmable data processing device, or other apparatuses to cause a series of operational steps to be performed on the computer, other programmable apparatus or other device to produce a computer implemented process, such that the instructions which execute on the computer, other programmable devices, or other apparatus implement the functions/operations specified in the flowchart and/or block diagram block or blocks.

The flowchart and block diagrams in drawings illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur in an order different from that noted in the figures. For example, two blocks shown in succession may, in fact, be executed substantially concurrently, or the blocks may sometimes be executed in the reverse order, depending upon the functionality involved. It should also be noted that each block of the block diagrams and/or flowchart illustration, and combinations of blocks in the block diagrams and/or flowchart illustration, can be implemented by special purpose hardware-based systems that perform the specified functions or operations, or combinations of special purpose hardware and computer instructions.

The computer program product may be implemented in hardware, software, or a combination thereof. In an optional example, the computer program product is embodied as a computer storage medium, and in another optional example, the computer program product is embodied as a software product, such as a software development kit (SDK), etc.

Various embodiments of the present disclosure have been described above. The above description is exemplary, not exhaustive. The present disclosure is not limited to those embodiments. Modifications and variations without departing from the scope and spirit of the embodiments will be apparent to a person skilled in the art. The terms used herein are intended to best explain the principles and practical applications of the embodiments and explain how they improve on the techniques on the market, or to enable persons other than a person skilled in the art to understand the embodiments.

What is claimed is:

1. An image processing method comprising:
acquiring at least one of a backward propagation feature of an (x+1)th video frame in a video segment or a forward propagation feature of an (x−1)th video frame in the video segment, wherein the video segment includes N video frames, N being an integer greater than 2, and x being an integer;
deriving a reconstruction feature of an xth video frame from at least one of the xth video frame, the backward propagation feature of the (x+1)th video frame, or the forward propagation feature of the (x−1)th video frame; and
deriving a target video frame corresponding to the xth video frame by reconstructing the xth video frame based on the reconstruction feature of the xth video frame, wherein the target video frame has a resolution higher than that of the xth video frame.

2. The method according to claim 1, wherein in a case of 1<x<N, deriving the reconstruction feature of the xth video frame from at least one of the xth video frame, the backward propagation feature of the (x+1)th video frame, or the forward propagation feature of the (x−1)th video frame comprises:
determining a backward propagation feature of the xth video frame based on the xth video frame, the (x+1)th video frame, and the backward propagation feature of the (x+1)th video frame;
determining a forward propagation feature of the xth video frame based on the xth video frame, the (x−1)th video frame, the forward propagation feature of the (x−1)th video frame, and the backward propagation feature of the xth video frame; and
using the forward propagation feature of the xth video frame as the reconstruction feature of the xth video frame.

3. The method according to claim 2, wherein determining the backward propagation feature of the xth video frame based on the xth video frame, the (x+1)th video frame, and the backward propagation feature of the (x+1)th video frame comprises:
deriving a first optical flow diagram from the xth video frame and the (x+1)th video frame;
deriving a distorted backward propagation feature by distorting the backward propagation feature of the (x+1)th video frame based on the first optical flow diagram; and
deriving the backward propagation feature of the xth video frame from the distorted backward propagation feature and the xth video frame.

4. The method according to claim 2, wherein determining the forward propagation feature of the xth video frame based on the xth video frame, the (x−1)th video frame, the forward propagation feature of the (x−1)th video frame, and the backward propagation feature of the xth video frame comprises:
deriving a second optical flow diagram from the xth video frame and the (x−1)th video frame;
deriving a distorted forward propagation feature by distorting the forward propagation feature of the (x−1)th video frame based on the second optical flow diagram; and
deriving the forward propagation feature of the xth video frame from the backward propagation feature of the xth video frame, the distorted forward propagation feature, and the xth video frame.

5. The method according to claim 1, wherein in a case of 1<x<N, deriving the reconstruction feature of the xth video frame from at least one of the xth video frame, the backward propagation feature of the (x+1)th video frame, or the forward propagation feature of the (x−1)th video frame comprises:
determining a forward propagation feature of the xth video frame based on the xth video frame, the (x−1)th video frame, and the forward propagation feature of the (x−1)th video frame;
determining a backward propagation feature of the xth video frame based on the xth video frame, the (x+1)th video frame, the backward propagation feature of the (x+1)th video frame, and the forward propagation feature of the xth video frame; and
using the backward propagation feature of the xth video frame as the reconstruction feature of the xth video frame.

6. The method according to claim 5, wherein determining the forward propagation feature of the xth video frame based on the xth video frame, the (x−1)th video frame, and the forward propagation feature of the (x−1)th video frame comprises:
deriving a second optical flow diagram from the xth video frame and the (x−1)th video frame;
deriving a distorted forward propagation feature by distorting the forward propagation feature of the (x−1)th video frame based on the second optical flow diagram; and
deriving the forward propagation feature of the xth video frame from the distorted forward propagation feature and the xth video frame.

7. The method according to claim 5, wherein determining the backward propagation feature of the xth video frame based on the xth video frame, the (x+1)th video frame, the backward propagation feature of the (x+1)th video frame, and the forward propagation feature of the xth video frame comprises:
deriving a first optical flow diagram from the xth video frame and the (x+1)th video frame;
deriving a distorted backward propagation feature by distorting the backward propagation feature of the (x+1)th video frame based on the first optical flow diagram; and
deriving the backward propagation feature of the xth video frame from the distorted backward propagation feature and the xth video frame.

8. The method according to claim 1 wherein in a case of x=1, deriving the reconstruction feature of the xth video frame from at least one of the xth video frame, the backward propagation feature of the (x+1)th video frame, or the forward propagation feature of the (x−1)th video frame comprises:
deriving a forward propagation feature of the xth video frame by performing feature extraction on the xth video frame; and
using the forward propagation feature of the xth video frame as the reconstruction feature of the xth video frame.

9. The method according to claim 1, wherein in a case of x=N, deriving the reconstruction feature of the xth video frame from at least one of the xth video frame, the backward propagation feature of the (x+1)th video frame, or the forward propagation feature of the (x−1)th video frame comprises:
deriving a backward propagation feature of the xth video frame by performing feature extraction on the xth video frame; and
using the backward propagation feature of the xth video frame as the reconstruction feature of the xth video frame.

10. The method according to claim 1, wherein in a case of x=1, deriving the reconstruction feature of the xth video frame from at least one of the xth video frame, the backward propagation feature of the (x+1)th video frame, or the forward propagation feature of the (x−1)th video frame comprises:
acquiring the backward propagation feature of the (x+1)th video frame for the xth video frame;
deriving a forward propagation feature of the xth video frame from the xth video frame and the backward propagation feature of the (x+1)th video frame; and
using the forward propagation feature of the xth video frame as the reconstruction feature of the xth video frame.

11. The method according to claim 1, wherein in a case of x=N, deriving the reconstruction feature of the xth video frame from at least one of the xth video frame, the backward propagation feature of the (x+1)th video frame, or the forward propagation feature of the (x−1)th video frame comprises:
acquiring the forward propagation feature of the (x−1)th video frame for the xth video frame;
deriving a backward propagation feature of the xth video frame from the xth video frame and the forward propagation feature of the (x−1)th video frame; and
using the backward propagation feature of the xth video frame as the reconstruction feature of the xth video frame.

12. The method according to claim 1, further comprising:
determining at least two key frames in video data; and
dividing the video data into at least one video segment based on the key frames.

13. An image processing device comprising:
a processor; and
a memory configured to store processor-executable instructions,
wherein the processor is configured to invoke the instructions stored in the memory, so as to:
acquire at least one of a backward propagation feature of an (x+1)th video frame in a video segment or a forward propagation feature of an (x−1)th video frame in the video segment, wherein the video segment includes N video frames, N being an integer greater than 2, and x being an integer;
derive a reconstruction feature of an xth video frame from at least one of the xth video frame, the backward propagation feature of the (x+1)th video frame, or the forward propagation feature of the (x−1)th video frame; and
derive a target video frame corresponding to the xth video frame by reconstructing the xth video frame based on the reconstruction feature of the xth video frame, wherein the target video frame has resolution higher than that of the xth video frame.

14. The device according to claim 13, wherein in a case of 1<x<N, deriving the reconstruction feature of the xth video frame from the at least one of the xth video frame, the backward propagation feature of the (x+1)th video frame, or the forward propagation feature of the (x−1)th video frame comprises:
determine a backward propagation feature of the xth video frame based on the xth video frame, the (x+1)th video frame, and the backward propagation feature of the (x+1)th video frame;
determine a forward propagation feature of the xth video frame based on the xth video frame, the (x−1)th video frame, the forward propagation feature of the (x−1)th video frame, and the backward propagation feature of the xth video frame; and
use the forward propagation feature of the xth video frame as the reconstruction feature of the xth video frame.

15. The device according to claim 14, wherein determining the backward propagation feature of the xth video frame based on the xth video frame, the (x+1)th video frame, and the backward propagation feature of the (x+1)th video frame comprises:
derive a first optical flow diagram from the xth video frame and the (x+1)th video frame;
derive a distorted backward propagation feature by distorting the backward propagation feature of the (x+1)th video frame based on the first optical flow diagram; and
derive the backward propagation feature of the xth video frame from the distorted backward propagation feature and the xth video frame.

16. The device according to claim 14, wherein determining the forward propagation feature of the xth video frame based on the xth video frame, the (x−1)th video frame, the forward propagation feature of the (x−1)th video frame, and the backward propagation feature of the xth video frame comprises:
derive a second optical flow diagram from the xth video frame and the (x−1)th video frame;
derive a distorted forward propagation feature by distorting the forward propagation feature of the (x−1)th video frame based on the second optical flow diagram; and
derive the forward propagation feature of the xth video frame from the backward propagation feature of the xth video frame, the distorted forward propagation feature, and the xth video frame.

17. The device according to claim 13, wherein in a case of 1<x<N, deriving the reconstruction feature of the xth video frame from the at least one of the xth video frame, the backward propagation feature of the (x+1)th video frame, or the forward propagation feature of the (x−1)th video frame comprises:
determine a forward propagation feature of the xth video frame based on the xth video frame, the (x−1)th video frame, and the forward propagation feature of the (x−1)th video frame;
determine a backward propagation feature of the xth video frame based on the xth video frame, the (x+1)th video frame, the backward propagation feature of the (x+1)th video frame, and the forward propagation feature of the xth video frame; and
use the backward propagation feature of the xth video frame as the reconstruction feature of the xth video frame.

18. The device according to claim 17, wherein determining the forward propagation feature of the xth video frame based on the xth video frame, the (x−1)th video frame, and the forward propagation feature of the (x−1)th video frame comprises:
derive a second optical flow diagram from the xth video frame and the (x−1)th video frame;
derive a distorted forward propagation feature by distorting the forward propagation feature of the (x−1)th video frame based on the second optical flow diagram; and
derive the forward propagation feature of the xth video frame from the distorted forward propagation feature and the xth video frame.

19. The device according to claim 17, determining the backward propagation feature of the xth video frame based on the xth video frame, the (x+1)th video frame, the backward propagation feature of the (x+1)th video frame, and the forward propagation feature of the xth video frame comprises:
derive a first optical flow diagram from the xth video frame and the (x+1)th video frame;
derive a distorted backward propagation feature by distorting the backward propagation feature of the (x+1)th video frame based on the first optical flow diagram; and
derive the backward propagation feature of the xth video frame from the forward propagation feature of the xth video frame, the distorted backward propagation feature, and the xth video frame.

20. A non-transitory computer-readable storage medium storing computer program instructions which, when executed by a processor, implement a method of:
acquiring at least one of a backward propagation feature of an (x+1)th video frame in a video segment or a forward propagation feature of an (x−1)th video frame in the video segment, wherein the video segment includes N video frames, N being an integer greater than 2, and x being an integer;
deriving a reconstruction feature of an xth video frame from at least one of the xth video frame, the backward propagation feature of the (x+1)th video frame, or the forward propagation feature of the (x−1)th video frame; and
deriving a target video frame corresponding to the xth video frame by reconstructing the xth video frame based on the reconstruction feature of the xth video frame, wherein the target video frame has a resolution higher than that of the xth video frame.
